(19) United States
(12) Patent Application Publication
(10) Pub. No.: US 2007/0295164 A1
(43) Pub. Date: Dec. 27, 2007

(54) Centrifugal mass drive

(76) Inventor: Harold Ariel Tavarez, Long Beach, CA (US)

Correspondence Address: HAROLD TAVAREZ, APT 2, 2501 EAST 4th STREET, LONG BEACH, CA, 90814, US

(21) Appl. No.: 11/448,433

(22) Filed: Jun. 7, 2006

(51) Int. Cl. F16H 27/04; F03G 3/00

(52) U.S. Cl. 74/84 S

(57) ABSTRACT

A propellantless propulsion device comprising a rotary platform to carry and convey rotary energy to a plurality of weights in orbit about a center of revolution. The weights are arranged in such a manner as to provide a continuous distribution of mass on one side of the rotary drive during a cycle of revolution. The continuous distribution of mass generates a continuous output of unbalanced centrifugal force components in one direction. A device for reducing the weights' radius of gyration for a portion of the total time in orbit about the center of revolution; the device may include the counter-rotation of the weights for that segment of travel in the orbital trajectory. The reduction in radius of gyration minimizes the magnitude of the centrifugal force components produced in the direction opposing the desired direction of propulsion. The variations in the trajectory of the weights' orbit generate the unbalanced centrifugal force components that generate a propellantless propulsion force in one direction.

### BACKGROUND-FIELD OF INVENTION

The present invention employs the centrifugal forces of weights in orbit about a center of revolution to make an unbalanced centrifugal force, useful for conversion to a linear force, useful for propellantless propulsion, and therefore useful to propel modes of transportation such as automobiles, marine vessels, aviation and spaceships, modes of communication like satellites in orbit, and the like.

### DESCRIPTION OF PRIOR ART

Current state of the art propulsion technology generates thrust by way of propellant acceleration. Propellers and jet propulsion engines accelerate a mass of fluid from the environment. A rocket accelerates the propellant it carries. In electric field, plasma and ion propulsion engines, atomic particles and molecules are the propellant. The present-day propellant acceleration technology is dominant and useful; yet, the operation of the propulsion devices built with the technology is limited by the propellant available for thrust. On the other hand, a practical propulsion technology without propellant can be achieved by making use of centrifugal forces. By controlling the orbital trajectory of a mass in motion about a center of revolution, considerable amounts of unbalanced centrifugal forces can be developed in one direction.

To make a centrifugal force, a mass in motion along a curved path will exert a force against an object directing the motion, or an object restraining the motion. The magnitude of the centrifugal force produced is directly proportional to the mass, the radius of gyration, and the square of the angular velocity. Accordingly, centrifugal forces of considerable magnitudes can be fashioned with the investment of modest amounts of energy in accordance with the law of conservation of momentum. Moreover, to make a centrifugal force, the discharge of a mass from the device that generates the centrifugal force is not a necessary. For that reason, a centrifugal force is a propellantless force since it is not necessary to eject a mass into the environment to produce it. Therefore, a propulsion device that employs a centrifugal force as a source of thrust is also a propellantless propulsion device.

Accordingly, to generate an unbalanced centrifugal force in one direction, the path of an object in circular motion can be changed by altering the radius of gyration during one part of a cycle of revolution; and then altered again to change the magnitude of the centrifugal force produced during the same cycle of revolution. During part of the cycle of revolution, the radius of gyration may be kept large in order to produce a large centrifugal force in one direction. Then, on the other part of the cycle of revolution, the radius of gyration may be reduced in order to produce a much smaller centrifugal force in the opposite direction. The magnitude of the resultant unbalanced centrifugal force will be equal to the difference between the magnitudes of the opposing forces; in the direction of the larger centrifugal force.

For example, to produce an unbalanced centrifugal force in one direction; for the first 180° of a cycle of revolution, an arm carrying a mass revolving about the center of revolution with a large radius of gyration generates a considerable large centrifugal force. On the next 180°, the radius of gyration is made smaller to reduce the magnitude of the centrifugal force produced in the opposite direction. During the first part of the cycle of revolution, the mass travels in a large radius of gyration, and the resultant centrifugal force is a pulse of thrust in the shape of one half of a sine wave. The centrifugal wave pulse of thrust increases and attains a maximum at the 90° position, and then decreases to zero at the 180° position. During the next 180°, the radius of gyration is reduced and the resultant one half wave sinusoidal pulse of thrust once again increases; except this time in the opposite direction. However, in this instance, the sine wave pulse increases to a lesser magnitude in comparison to the first pulse. The net magnitude of the resultant unbalanced centrifugal force is in the shape of a sinusoidal pulse of thrust of time varying magnitude, in the direction of the larger centrifugal force. The addition of a second arm generates an additional sine wave pulse of thrust. The more arms added, the greater the magnitude of the resultant unbalanced centrifugal force. The vector addition of all the centrifugal forces produced by this approach generates a high frequency sinusoidal ripple of force that includes unwanted vibrations. In addition, this particular approach is too restrictive and complex due to the limiting number of arms that can be used in the same plane of revolution. It is also complex due to the increasing number of arms with weights that must be added to approximate a vibration free and stable propulsive thrust output. As the number of arms increases, the device becomes more complex and the frequency of the sine wave ripples of force also increases. The frequency of the sine wave ripples of centrifugal force is proportional to the number of arms and the frequency of the arms rotation in revolutions per second. Accordingly, the net rate of change in the magnitude of the unbalanced centrifugal force output produced by multiple arms with weights varies in proportion to the magnitude of the centrifugal force, and the frequency of the individual sinusoidal wave ripples of force. In the teachings of the prior art, several devices and methods for centrifugal force propulsion can be found. One of the proposed methods consists of a mass exchange between counter rotating arms. On one side of the device, the mass exchange between the counter rotating arms generates an unbalanced centrifugal impulse of thrust in the shape of one half of a sine wave. A similar mass exchange among multiple arms generates similar transitory centrifugal sine wave pulses of thrust. Another method of centrifugal force propulsion consists in varying the radius of gyration of sets of discrete bodies of mass in weighted arms. Other methods and techniques also involve the same multiple arms with weights approach, and/or variations in velocity of gyration at different moments in time during a cycle of revolution.

However, in considering as to what have been achieved in this particular area of propulsion until today; the achievement have been a repetition of the same means and methods of centrifugal force propulsion as contained in the prior art. The advances made with the methodology of the prior art come with the same assortments of disadvantages and limitations. The devices built by in accordance with the principles of the prior art are exceedingly complex and unreliable. They require complex mechanisms for the rotation of multiple weighted arms with parcels of masses that generate the unbalanced the centrifugal forces for propulsion. Moreover, the proposed prior art machines do not generate a directionally continuous and stable unbalanced centrifugal force in one direction at a constant magnitude. At best, the prior art machines generate directional sinusoidal wave pulses of thrust in an unreliable operation that includes unwanted vibrations. The overall timing and magnitude of the centrifugal pulses of thrust produced are predetermined by the degree of separation between the weighted arms carrying the masses that generate the centrifugal forces. Furthermore, due to these and various limitations, the devices of the prior art have yet to find practical, useful, and successful applications in the field of propulsion.

While the general principles of operation in the prior art may be well known by those practicing the particular art, what is not known and resolved until now, is how to produce a continuous and stable unbalanced centrifugal force in one direction at a constant magnitude in order to make it practical and useful for applications in propulsion.

### SUMMARY OF THE INVENTION

The present invention is a propulsion device making use of centrifugal forces to produce a continuous unbalanced centrifugal force in one direction. The invention comprises a rotary platform(s), a plurality of weights arranged in a continuous distribution of mass on the platform, and a suitable mechanism to vary the weights' radius of gyration during part of a cycle of revolution. The change in radius of gyration mechanism facilitates a change in the trajectory of a weight in orbit about a center of revolution. During a cycle of revolution, a weight in orbit about a center of revolution alternate between a maximum and a minimum radius of gyration. The change in radius of gyration generates a change in the magnitude of the centrifugal force produced by the weights. The mass distribution of sequential weights in orbit generates a continuous unbalanced centrifugal force in one direction. The resultant unbalanced centrifugal force is readily available for propulsion without propellant. The invention is useful as a prime mover for the propulsion of railway cars, passenger cars and trucks, vans, buses, service utility vehicles, aviation, marine vessels, spaceships, satellites in orbit, and the like.

### BRIEF DESCRIPTION OF THE DRAWINGS

FIG. 1 shows a plan view of a centrifugal mass drive.

FIG. 2 is a cross sectional side view of the centrifugal mass drive shown in FIG. 1.

FIG. 3 shows a centrifugal thrust generator along the line AA′ in FIG. 2.

FIG. 4 shows that the weights in a centrifugal mass drive are segments of an annulus.

FIG. 5 shows a plan view of a centrifugal mass drive with an improved stator.

FIG. 6 is a cross section of the improved centrifugal mass drive in FIG. 5.

FIG. 7 shows a plan view of another version of a centrifugal mass drive.

FIG. 8 is a cross section of the centrifugal mass drive in FIG. 7.

FIG. 9A is a view of the lower centrifugal thrust rotor along BB′ in FIG. 8.

FIG. 9B is a view of the lower centrifugal thrust rotor along CC′ in FIG. 8.

FIG. 10A is a view of the upper centrifugal thrust rotor along DD′ in FIG. 8.

FIG. 10B is also a view of the upper centrifugal thrust rotor along the EE′ in FIG. 8.

FIG. 11 shows a plan view of another adaptation of a centrifugal mass drive.

FIG. 12 is a cross sectional side view of the centrifugal mass drive shown in FIG. 11.

FIG. 13 is a plan view of an improved adaptation of the centrifugal mass drive in FIG. 11.

FIG. 14 is a cross sectional view of the centrifugal mass drive in FIG. 13.

FIG. 15 is a plan view of an improved adaptation of the centrifugal mass drive in FIG. 13 with an improved centrifugal thrust stator.

FIG. 16 is a cross sectional view of the centrifugal mass drive in FIG. 15.

FIG. 17 shows a plan view of another adaptation of a continuous distribution of mass to make a new centrifugal mass drive.

FIG. 18 is a cross sectional view of the centrifugal mass drive in FIG. 17.

FIG. 19 is a view along FF′ in FIG. 18 to show the continuous distribution of mass inside the centrifugal mass drive in FIG. 17.

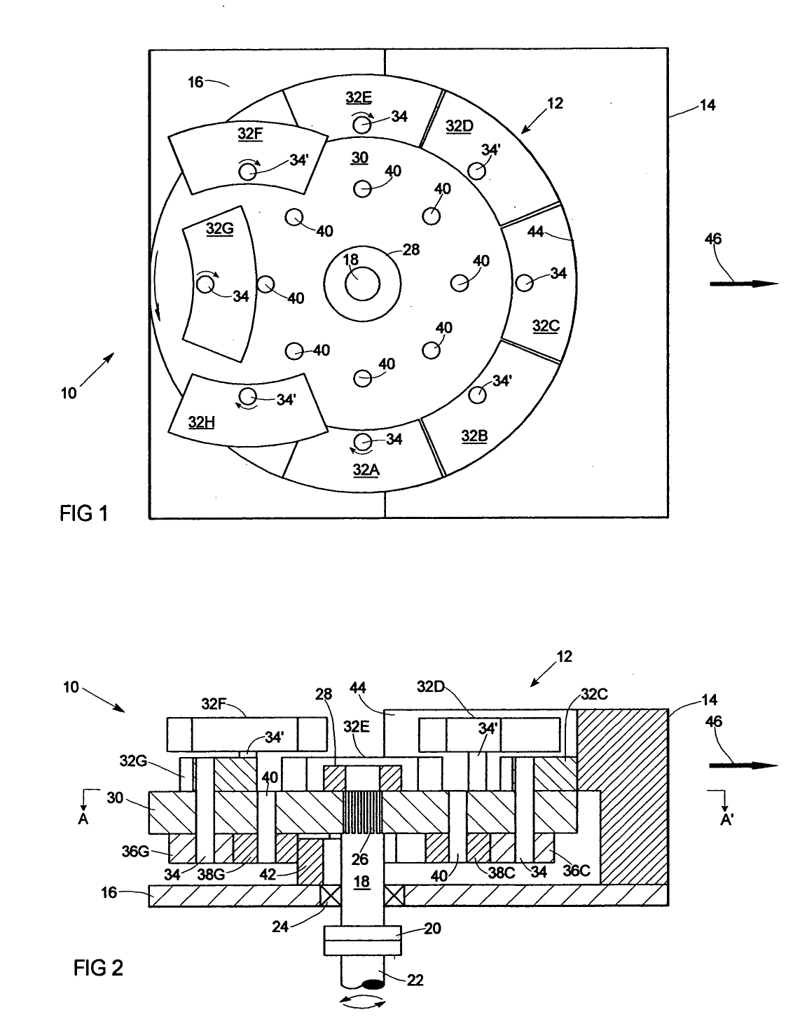

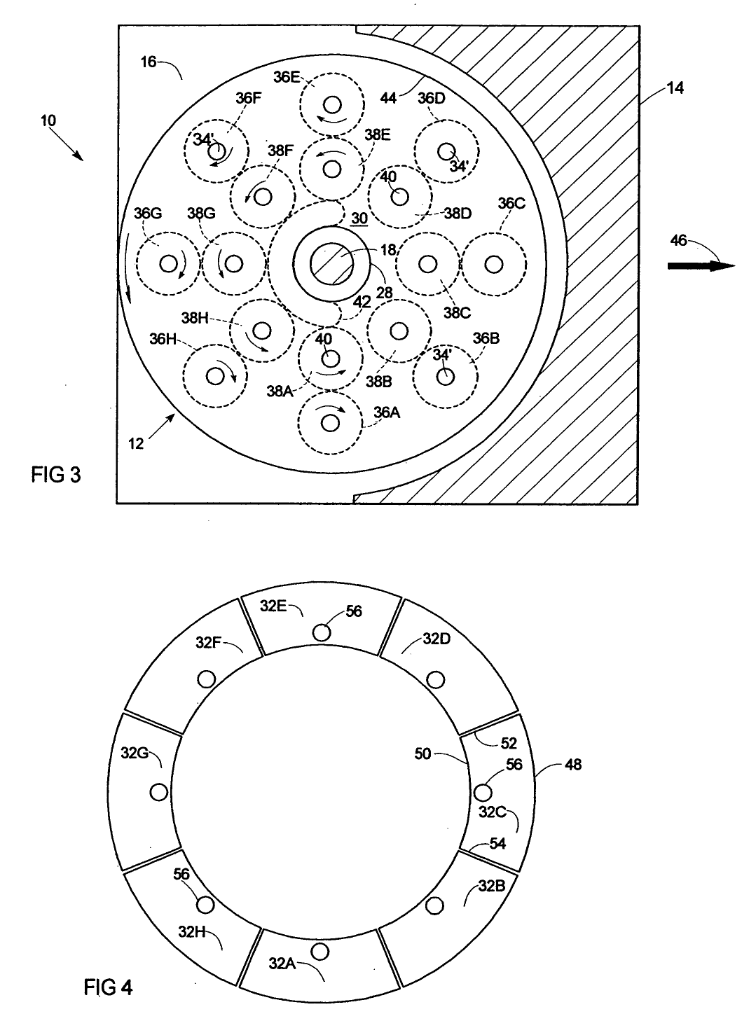

### FIG. 1, FIG. 2, AND FIG. 3

FIG. 1 is a plan view of a centrifugal mass drive 10. The mass drive 10 comprises a centrifugal thrust generator 12, a centrifugal thrust stator 14 on a base frame 16; a central shaft 18 engages a transmission 20 coupling with a drive shaft 22. The shaft 18 defines a center of revolution in the mass drive 10. The shaft 22 is part of a rotary drive (not shown) that supplies the torque to spin the thrust generator 12. A bearing 24 in the frame 16 provides structural support and facilitates the rotation of the shaft 18 with the thrust generator 12. On one end of the shaft 18, a set of gear teeth 26 engages a rotor 30 (best shown in FIG. 2). A retainer mass 28 secures the rotor 30 to the shaft 18. The mass 28 may be a nut, an annulus with set screws, or any other suitable device fit for locking in place the thrust generator 12 to the shaft 18. The thrust generator 12 comprises the disk shaped platform of the rotor 30 carrying a plurality of weights 32A-32H, a plurality of outer gears 36A-36H (best shown in FIG. 3), and inner gears 38A-38H with corresponding shafts 34 and 34′ and 40. The weights 32A-32H are on one side of the rotor 30, and the corresponding sets of outer gears 36A-36H, and inner gears 38A-38H are on the opposite side. Several shafts 34 and 34′ connect each of the weights 32A-32H on one side of the rotor 30 to corresponding gears 36A-36H on the opposite side of the rotor 30 for unitary operation. Also, each of the gears 36A-36H engages a corresponding inner gear 38A-38H. Each of the gears 38A-38H have a shaft 40. A timing stator 42 on the frame 16 engages inner gears 38A-38H at different times and for only a fraction of the total time in a cycle of revolution. The position of the stator 42 determines when, and its length determines for how long the inner gears 38A-38H spin in order to counter spin the weights 32A-32H during a part of the cycle of revolution. The inner gears 38A-38H spin in the same direction as the rotor 30 to cause the outer gears 36A-36H to spin the weights 32A-32H in the opposite direction during the part of the cycle of revolution. The stator 14 provides a centrifugal thrust wall 44 in the form of an arcuate plane surface to guide the orbital path of the weights 32A-32H during a portion of the total cycle of revolution. The surface of the thrust wall 44 provides a thrust plane on which the weights 32A-32H discharge the centrifugal forces they generate for propulsion. The vector sum of all the unbalanced centrifugal force components generated by the weights 32A-32H, act on the thrust plane of the wall 44 and generates the vector of the propellantless propulsion force 46. The propulsion force 46 is a linear force useful to propel any vehicle to which the mass drive 10 is attached to achieve linear motion in the direction of the propulsion force 46.

FIG. 2 is a cross sectional view of the mass drive 10 shown in FIG. 1. FIG. 1 provides the sight of a steady state constant and continuous flow of mass through to the stator 14. The cross section in FIG. 2 shows the weights 32C, 32E, and 32G in one plane of revolution. While the weights 32D and 32F are in another parallel and adjacent plane of revolution. The arrangement of the weights 32A-32H on the rotor 30 allow for a continuous distribution of mass on one side of the rotor 30. The sequential mass spread of the weights 32A-32H on two parallel planes of revolution facilitates the operation of the weights 32A-32H free from the mutual interference of each other. The simultaneous operation of the weights 32A-32H in two parallel planes of revolution generates a continuous input of constant magnitude centrifugal forces on the thrust plane of the wall 44. Consequently, the propulsive thrust output of the mass drive 10 is also a continuous unbalanced centrifugal force in one direction.

### Operation

FIG. 1 illustrates the concept of how a centrifugal mass drive 10 generates a continuous unbalanced centrifugal force in one direction. The mass drive 10 includes the centrifugal thrust generator 12 comprising a plurality of weights 32A-32H, gears 36A-36H, and gears 38A-38H with corresponding shafts 34 and 34′ and 40. The thrust generator 12 employs a novel distribution of mass as shown by the arrangement of the weights 32A-32H on the rotor 30. The weights 32A-32H operate in two adjacent and parallel planes of revolution. The mass in the weights 32A-32H is spread out in a fashion as to create a constant and continuous flow of mass on the thrust plane of the wall 44, shown in FIG. 1. The shaft 18, coupled to the transmission 20 receives a torque input from the drive shaft 22. The torque input spin the centrifugal thrust generator 12 comprising the rotor 30 with the weights 32A-32H, the gears 36A-36E, and 38A-38H with the shafts 34, 34′ and 40. A view of the gears 36A-36H, and 38A-38H is best shown in FIG. 3. The arrangement of the weights 32A-32E on the rotor 30 shows that, during a propulsive cycle of revolution, a constant and continuous flow of equal amounts of mass per unit of time and pass through the point of maximum centrifugal force output at all times. FIG. 1 illustrates a selected moment in time during a cycle of revolution. In that instant of time, and in relation to the shaft 18, the weights 32A-32E travels in the trajectory of a semicircular orbit at a constant radius of gyration. The curvature of the wall 44 restrains the weights 32A-32E to follow in the path of a semicircular orbit.

In particular to the weights 32A and 32E only, the weight 32A is in the process of ending a cycle of revolution about its own axis of gyration as defined by its own shafts 34, and at the start of a new trajectory in the path of a semicircular orbit about the shaft 18. On the opposite side, the weight 32E is in the process of starting a cycle of gyration about its own shafts 34 as it also travels in orbit around the shaft 18. In the mass drive 10, there is a position on which any of the weights 32A through H attain a maximum contribution of centrifugal force components in the desired direction of linear force output, the direction of maximum unbalanced centrifugal force output. At the start, the weight 32A is in the initial position of a semicircular cycle of revolution about the shaft 18. The weight 32A is in contact with the thrust wall 44 in the stator 14. The weight 32B is advancing toward the position of maximum centrifugal force components output in the direction of the propulsion force 46. Next, the weight 32C is in the position of maximum unbalanced centrifugal force output. Components of mass in the weight 32C are at, arriving at, and leaving the position that contributes to maximum centrifugal force vector components in the desired direction of propulsion, in the direction shown with the arrow of the propulsion force 46. In the mean time, the weight 32D is at some distance away from the position of maximum propulsive thrust output, producing centrifugal force components of a lesser magnitude in the direction of the propulsion force 46. At the end of the contribution of maximum unbalanced centrifugal force components to the propulsion thrust cycle is the weight 32E. In that position, the corresponding gear 38E comes in contact with the timing stator 42 to starts a spin cycle of counter rotation in a direction opposite to the rotor 30 direction of rotation. FIG. 3 shows the initial contact between the inner gear 38E and the stator 42. In that position, and during the counter rotation cycle, the centrifugal force components produced by the weight 32E in the desired direction of propulsion are minimized. In contrast, the weights 32F, 32G, and 32H are in the process of carrying out a cycle of revolution about their own shafts 34 and 34′, in addition to revolving about the shaft 18. The rotor 30 revolves about the shaft 18 in one direction, while the weights 32E, 32F, 32G, and 32H spin in the opposite direction during the time of travel through the path of minimum radius of gyration.

FIG. 3 is a view taken along AA′ in FIG. 2 to show the gears 36A-36H and 38A-38H. The view along AA′ is taken just below the level the weights 32A-32H. FIG. 3 shows the gears 38F, 38G, and 38H in contact with the stator 42. Contact with stator 42 spin the gears 38F, 38G, and 38H in the same direction of the rotor 30 in order to cause the gears 36F, 36G, and 36H to spin in the opposite direction. During contact with the stator 42, the uniry operation of the weights 32A-32H with the gears 32A-32E spin the weights 32A-32H in a direction opposite to the direction of the rotor 30. As shown in the FIG. 1, the counter rotation of the weight 32G decreases its radius of gyration to a minimum and bring the weight 32G closer to the shaft 18. The synergy of the counter rotation and the reduction in radius of gyration generate minimum opposing centrifugal forces. The minimized radius of gyration, in relation to the shaft 18, decreases the magnitude of the opposing centrifugal forces to the direction of the propulsion force 46. In addition, as the weights 32A-32H counter-rotate; the spin also generates centrifugal force components about the shafts 34 and 34′. Thus counter spinning the weights 32A-32H adds to a further increase in the net magnitude of the resultant unbalanced centrifugal forces that generate the vector of the propulsion force 46.

In the generator 12, the shafts 34 and 34′ are equally spaced at the same radial distance from shaft 18. However, the shaft 34′ is longer than the shaft 34 in order to place the weights 32B, 32D, 32F and 32H in another parallel plane of revolution. They also displaced at the same angular spacing from each other. The gears 38A-38H are also spaced at the same radial and angular spacing with each other. All these components, gears and shafts, can be said to be of equal mass and dimensions to make a well balanced machine. During the gyrations of the thrust generator 12, for a well designed and balanced machine, the assemblies of the shafts 34 and 34′ and 40, the gears 32A-32E and 38A-38H do not generate a net thrust in any direction. Similarly, if the weights 32A-32H are of equal mass, length, width, and thickness, then grouping them together make a uniform ring of mass. Gyrations of the uniform annulus of mass will not generate a net thrust in any direction. Therefore, spinning a well balanced thrust generator 12 without the counter rotations of the weights 32A-32H; does not generate a net thrust either. However, by the inclusion of the counter rotations of the weights 32A-32H in a portion of the cycle of revolution generates directional unbalanced centrifugal forces useful for propellantless propulsion. In FIG. 1, during a cycle of revolution, a continuous and uniform amount of mass pass by the point of maximum unbalanced centrifugal force output in the stator 14. In FIG. 2, it can be seen that from the viewpoint of FIG. 1, one side of the mass drive 10 shows a continuous distribution of mass produced by the sequential arrangement of the weights 32A-32E. FIG. 2 shows a cross sectional view of the drive 10 showing two planes of rotation for the weights 32A-32H. Thus, under the said conditions, the net unbalanced centrifugal force produced by the centrifugal mass drive 10 comes from the orbital operations of the weights 32A-32H only.

FIG. 4 shows an annular arrangement of the weights 32A-32H by themselves. Gaps between the weights 32A-32H are included for symbolic illustration only. The weights 32A-32H are of similar construction, mass, and volume. The weight 32C shows an outer edge 48, an inner edge 50, lateral edges 52 and 54 and an aperture 56 to allow for the inclusion of a shaft (mass thickness not shown). From the number of symmetric masses in FIG. 4, the annulus is divided into eight equal masses, and each mass occupies an angle 45° wide. Without the aperture 56, each of the weights 32A-32H contains an equal amount of mass per unit of degree. Due to the symmetry of the masses, the gyrations of the annulus would not result in the net output of unbalanced centrifugal force components in any direction in the plane of rotation. However, with the inclusion of the aperture 56, the mass removed to make the aperture 56 can be compensated by the mass of the shafts 34 and 34′. If the mass density of the shafts 34 and 34′ differs from the mass density of a weight, then the insertion of the shafts 34 and 34′ in the aperture 56 can be adjusted accordingly to compensate for the missing mass. Similarly, as more hardware members are added to facilitate specific operations and thrust output in the mass drive 10, mass may be added or removed at specific locations in the mass of the weights 32A-32H to adjust accordingly. The end result is to achieve a constancy of mass per unit of degree so as to achieve a steady state constancy of centrifugal thrust output during a cycle of revolution.

Referring to FIG. 1 and FIG. 2, as the weights 32A-32H on the rotor 30 spin in orbit about the shaft 18. The orbital gyrations of the weights 32A, 32C, 32E, and 32G on one level; and the weights 32B, 32D, 32F, and 32H on another level define a control volume of operation. Using FIG. 4 as a reference and without the counter-spin of the weights 32A-32H, in the steady state in which there is a zero net propulsive thrust output, the shape of the control volume is cylindrical. The boundaries of the cylinder are defined by the spin of the weights 32A-32H on the two adjacent and parallel planes of revolution they occupy. The weights 32A, 32C, 32E, and 32G gyrate about the shaft 18 on one level; and the weights 32B, 32D, 32F, and 32H on gyrate on another level. Centrifugal forces are produced in all directions; however, the net centrifugal thrust output is zero. Conversely, during the operation that generates a net unbalanced centrifugal force in one direction, the magnitudes of the centrifugal forces change during parts of the cycle of revolution. For one part of the cycle of revolution, the weights 32A-32H travel is a semicircular trajectory in contact with the thrust plane provided by the wall 44. For the other part of the cycle of revolution, the weights 32A-32H spin about their own shafts 34 and 34′ and generate additional centrifugal forces. In the control volume itself, the geometry of the thrust wall shows that at every instant of time, there is a continuity of mass per unit of degree passing through the point of maximum and minimum centrifugal force output. Thus, the resultant unbalanced centrifugal force output is of a stable and constant magnitude. In FIG. 1, the weight 32C can be said to be in the location of maximum centrifugal force output in the desired direction of propulsion, shown with the arrow of the propulsion force 46. In that location, mass components in the weight 32C are at, arriving at, and leaving the point of maximum unbalanced centrifugal force output. On the opposing side, weight 32G spin in the opposite to the direction of the rotor 30. The mass per unit of degree passing through the point of minimum radius of gyration is also constant; and the magnitude of the unbalanced centrifugal force output available for propulsion without propellant in a steady state is continuous, stable, and constant.

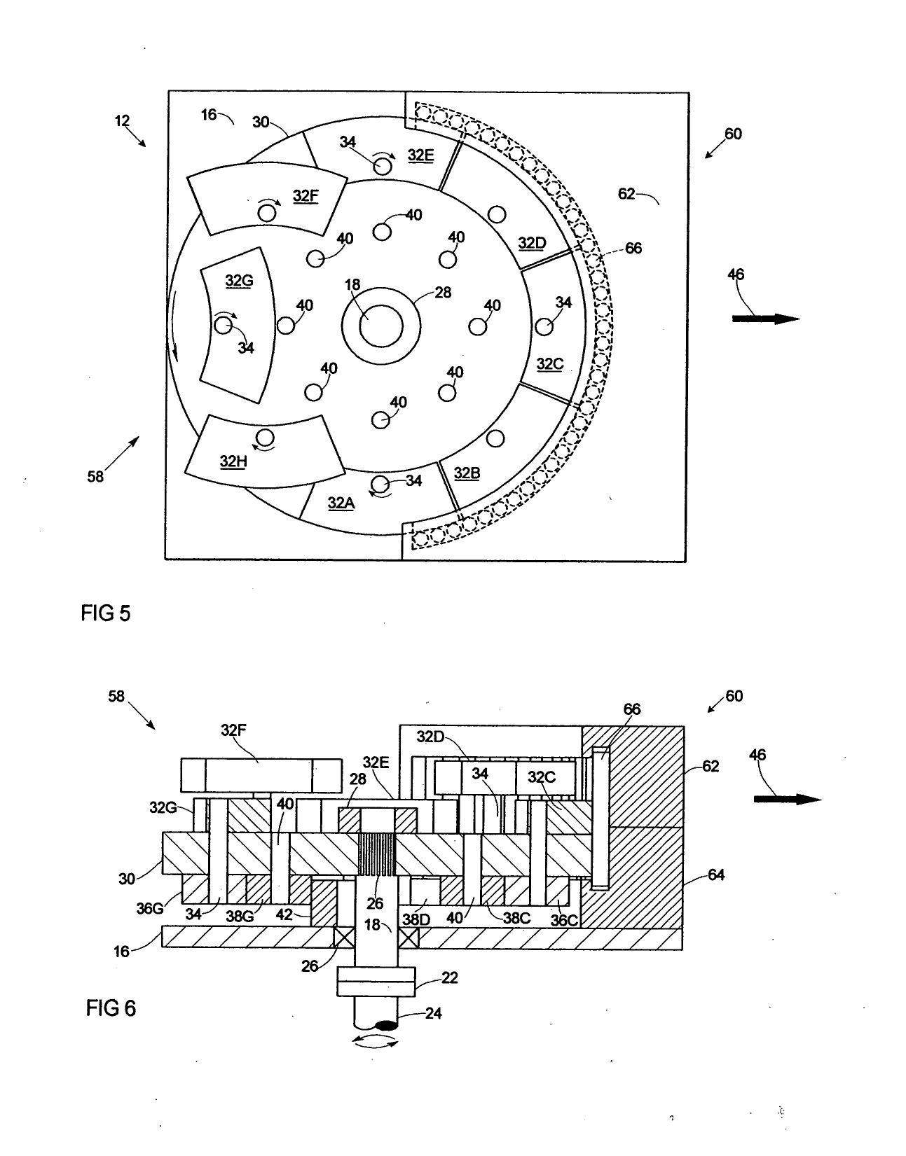

### FIG. 5 AND FIG. 6

FIG. 5 shows an improved centrifugal mass drive 58 and FIG. 6 is a cross section. In the mass drive 10, the weights 32A-32H slide on a low friction or a lubricated surface in the stator 14. The sliding motion of weights 32A-32H on the thrust plane of the wall 44 may possibly generate considerable friction. To reduce the friction, the mass drive 10 has been improved by transforming the stator 14 into a stator 60 comprising two symmetric channeled members 62 and 64 containing a plurality of rollers 66. The rollers 66 reduce the friction between the weights 32A-32H and the stator 60. Similar in function as the stator 14, the stator 60 guides the trajectory of the weights 32A-32H in the path of a semicircular arc, the plurality of rollers 66 define an improved thrust wall with reduced frictional losses that requires less torque to spin the thrust generator 12. Instead of pressing against a flat surface as with the thrust wall 44, the weights 32A-32H press against the rollers 66. With the exception of the modified stator 60, all the components in the mass drive 58 are the same as in the mass drive 10.

One additional modification relevant to the mass drives 10 and 58 would be the lengthening the shaft 18 to make possible the addition of a second rotary platform similar to the rotor 30. Another modification would include lengthening of the shafts 34 and 34′ into the second rotor to provide additional structural support for the operation of the weights 32A-32H. Another modification includes splitting the weights 32A-32H into two groups of four masses in each rotary platform. The weights 32A, 32C, 32E, and 32G on the rotor 30; and the weights 32B, 32D, 32F, and 32H on the second rotor with both rotary platforms adjacent, parallel, and facing each other. In this particular improvement, the corresponding gears assemblies, gears 36A-36H and 38A-38H corresponding to each of the weights 32A-32H would be located in each corresponding rotary platform. For the weights 32A, 32C, 32E, and 32G, the gears 36A, 36C, 36E, and 36G, and the gears 38A, 38C, 38E, and 38G will be placed on the rotor 30. On the second rotor, the weights 32B, 32D, 32F, and 32H, the gears 36B, 36D, 36F, and 36H, and the gears 38B, 38D, 38F, and 38H will be in place. A second structure for the operation of the second rotary platform may be added. The additional second structure with the necessary devices and connecting frames may be added and would also include at least a frame with a stator similar to the stator 42 to counter rotate the weights 32B, 32D, 32F, and 32H on the second rotor. As it relates to this particular approach, other combinations, modifications, and improvements may also be put into effect in the pursuit for additional propellantless propulsion engines.

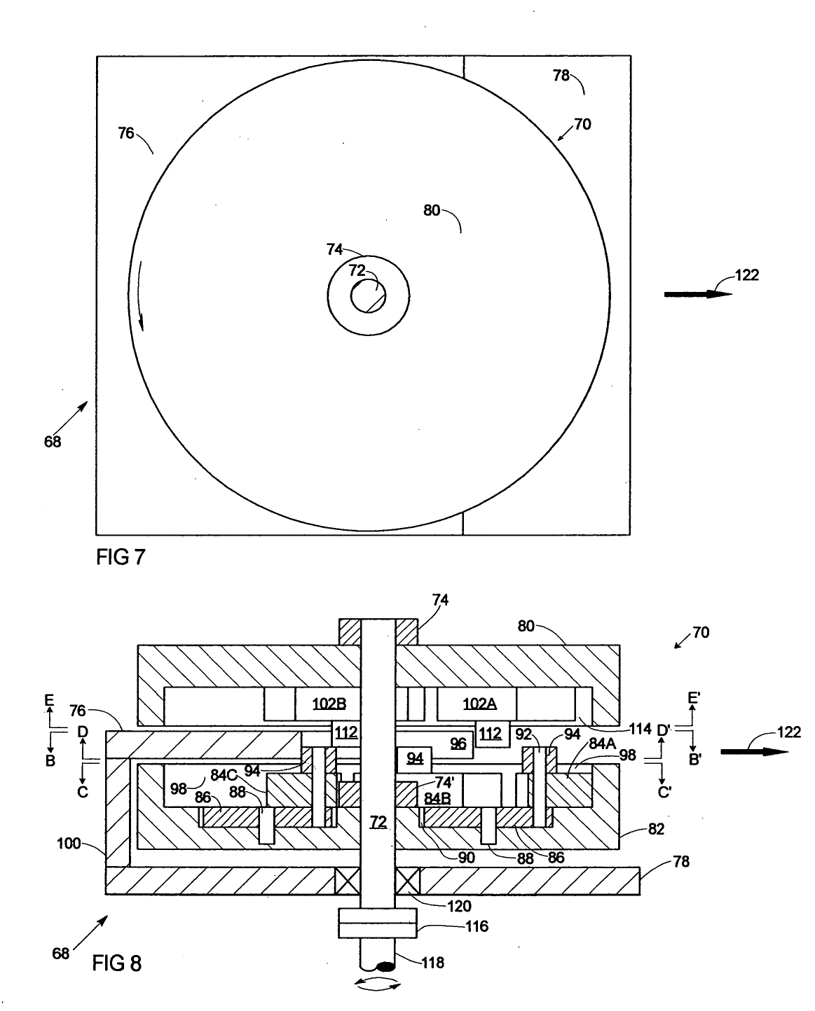

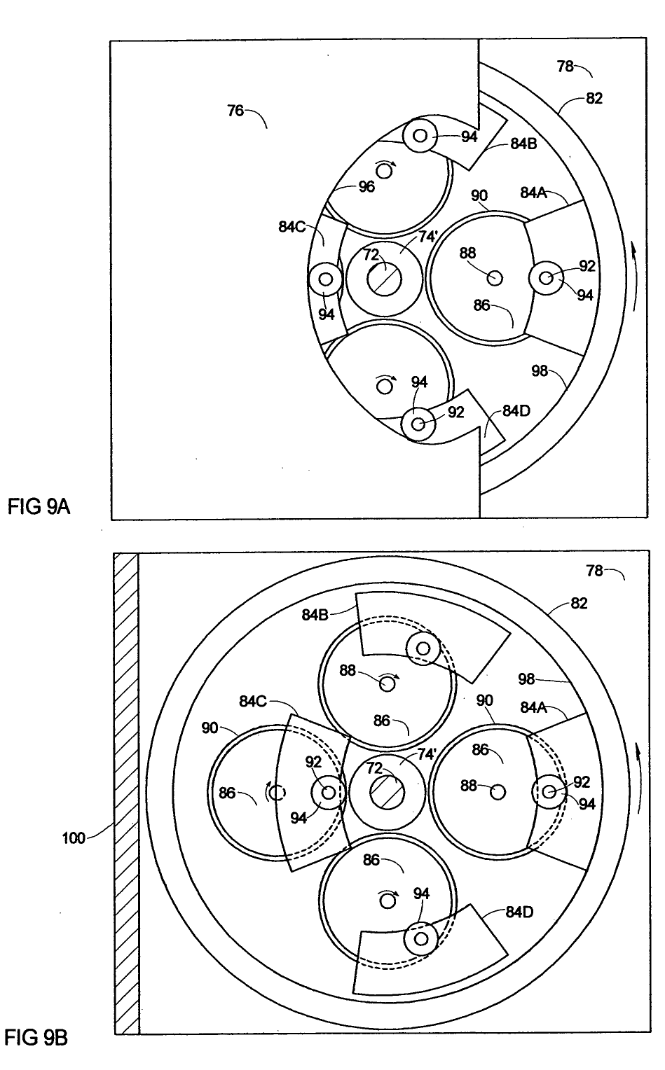

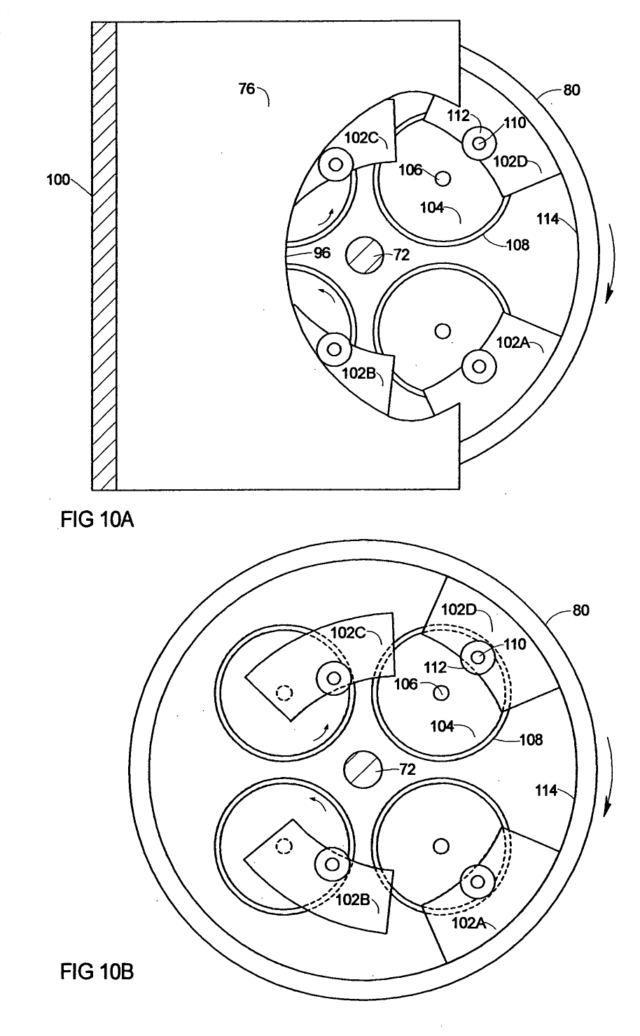

### FIG. 7, FIG. 8, FIG. 9A, FIG. 9B, FIG. 10A, AND FIG. 10B

FIG. 7 is a plan view of an improved centrifugal mass drive 68 featuring an improved centrifugal thrust generator 70. The improved thrust generator 70 is another method to achieve the counter rotation of a centrifugal force producing mass during part of a cycle of revolution about a central shaft. The thrust generator 70 is attached to a central shaft 72 and secured by masses 74. The operation of the thrust generator 70 is influenced by the presence of a radius minimizing stator 76. A centrifugal thrust rotor 80, a component in the thrust generator 70, generates a portion of the total propulsive thrust produced. The entire assembly is mounted on a base frame 78 and generates a propulsion force 122.

FIG. 8 is a cross section of the mass drive 68. The thrust generator 70 comprises centrifugal thrust rotors 80 and 82 fixed to the shaft 72 by retainer masses 74 and 74′. The masses 74 and 74′ may be devices of suitable design adapted for keying the rotors 80 and 82 to the shaft 72. In the cross sectional view and in reference to the rotor 82 only, FIG. 8 shows three of the masses that generate centrifugal forces. The weights 84A, 84B, and 84C are attached to a corresponding orbital rotor 86 with a shaft 88. The shaft 88 holds the rotor 86 inside a corresponding orbital chamber 90. Each of the weights 84A-84D (also shown in more detail in FIG. 9A and FIG. 9B) is joined to a corresponding rotor 86 and held in place by a shaft 92. On one end of the shaft 92 there is a wheel 94. The rotor 82 has the shape of a short partially hollow cylinder and provides the inner surface of a rotor wall 98 on which the mass of the weights 84A-84D press on to communicate the centrifugal forces they produce. During the next part of the cycle of revolution, the radius of gyration of the weights 84A-84D is reduced by a raceway 96 in the stator 76.

Similarly, for the rotor 80, FIG. 8 also shows two of the masses that generate centrifugal forces, weights 102A, and 102B. The rotor 80 also has the shape of a short hollow cylinder and provides the inner surface of a rotor wall 114 on which mass of the weights 102A-102D (also shown in FIG. 10A and FIG. 10B) press on to communicate the centrifugal forces they produce. During the next portion of the cycle of revolution about the shaft 72, the radius of gyration of the weights 102A-102D is also reduced by the raceway 96. The reduction in radius of gyration on all the weights 84A-84D and 102A-102D generates reduced centrifugal force vector components in a direction opposite to the direction of the linear force shown with the arrow of the propulsion force 122.

### FIG. 9A AND FIG. 9B

FIG. 9A and FIG. 9B are additional views of the rotor 82 at a particular instance in time in a cycle of revolution about the central shaft 72. FIG. 9A is a view along the line BB′ in FIG. 8. FIG. 9B is along the line CC′ in FIG. 8. FIG. 9A shows the effect of the stator 76 on the position of the weights 84A-84D as they spin together with the orbital rotors 86. The four weights 84A-84D in the rotor 82, are angularly spaced 90° apart.

In FIG. 9A, the wheels 94 for the weights 84B, 84C, and 84D are in contact with the raceway 96. The curvature in the raceway 96 alters the radius of gyration of each of the weights 84A-84D as they spin with the rotor 82. As an example, if the rotor 82 spins counterclockwise, shown with an arrow, then the wheel 94 that belongs to the weight 84B makes contact with the raceway 96 for the object of making a cycle of reduction in radius of gyration by spinning in a direction opposite to the direction of the rotor 82. The counter-spin gyrations are caused by the curvature of the raceway 96. The journey of the weight 84B on the raceway 96 decreases the radial distance until it arrives to the point of minimum radius of gyration. The weight 84C is already in the position of minimum radius of gyration. Beyond the position of minimum radius of gyration, the radius increases again at the end of the raceway 96, as in the case of the weight 84D which is just about to end the cycle of revolution about the shaft 72. During the entire journey through the raceway 96, the centrifugal forces generated in the opposite direction are of a reduced and minimized magnitude; in comparison to the larger centrifugal forces produced during the other part of the cycle of revolution. As a general rule, if the rotor 82 gyrates in one direction, the orbital rotor 86 will gyrate in the opposite direction. In FIG. 9A and FIG. 9B, the weight 84B is already drawn away from the rotor wall 98. The weight 84C in the middle is at a point of minimum radius of gyration with respect to the central shaft 72. At the position of minimum radius of gyration, the opposing centrifugal forces generated by the weight 84C are minimized by the reduced radius of gyration. In contrast, the weight 84D is about to finish a cycle of revolution about the shaft 72. The weight 84D is approaching the rotor wall 98. The weight 84A, in contact with wall 98, gyrates with the rotor 82 and generates maximum centrifugal forces and its own rotor 86 is not longer spinning. FIG. 9B is another view of FIG. 9A without the stator 76 in place. The brace 100 is a support that connects the stator 76 to the base frame 78.

FIG. 10A and FIG. 10B are two views of the rotor 80. FIG. 10A is along the line DD′ in FIG. 8 and FIG. 9B is along the line EE′. The rotors 80 and 82 are similar in construction and details. However, different part numbers are used to identify the components involved. The rotor 80 comprises the elements of four weights 102A-102D spaced 90° apart. Each of the weights 102A-102D is attached to one of the four orbital rotors 104 by shafts 110. Each of the rotors 104 is also inside one of the four orbital chambers 108 and secured by shafts 106 to the body of the rotor 80. One end of each of the shafts 110 has a wheel 112. FIG. 10A includes the stator 76 to show the positions of the weights 102A and 102ad as they spin with the rotor 80 in contact rotor wall 114. The wheels 112 for the weights 102B and 102C are in contact with the raceway 96 to alter their radius of gyration. FIG. 10B shows the rotor 80 only without the stator 76. The two views are pictures of a particular moment in time during a cycle of revolution. In total, the four views of FIG. 9A through 10B are of the same moment in time during a cycle of revolution. Even though the weights 84A-84D and the weights 102A-102D are in parallel planes of rotation, they provide a continuous distribution of mass passing through the maximum and minimum radius of gyration points at all times. For example, looking from above, the view would show a mass distribution of the four weights 84A-84D spaced 90° apart with the weights 102A-102D occupying the positions in between the angular space of the weights 84A-84D. With this particular continuity of mass arrangement, the continuous output of an unbalanced centrifugal can be achieved. The vector sum of the unbalanced centrifugal forces components acting on the shaft 72 generates the propulsion force 122.

A particular observation of FIG. 9A through FIG. 10B shows, that during a portion of the cycle of revolution about the central shaft 72, the weights 84A-84D and 102A-102D travel in a semicircular orbit of constant radius of gyration and generate maximum centrifugal forces in the desired direction of propulsion. For the rest of the cycle, the weights 84A-84D and 102A-102D travel in a reduced radius of gyration with a diminished output of centrifugal forces. Thus the net result is an unbalanced centrifugal force shown with the arrow of the propulsion force 122. Furthermore, the masses of the weights 84A-84D and 102A-102D are said to be able to spin with ease about the shafts 88 and 106 in order to adjust their orientation as they gyrate together with the rotors 80 and 82 about the shaft 72.

FIG. 7 as well as FIG. 8 shows that the thrust generator 70 spins together with the central shaft 72. The shaft 72 pass through the base frame 78 and connects to a transmission 116. A bearing 120 in the frame 78 provides a structural support for the thrust generator 70. The transmission 116 also connects to a drive shaft 118. The shaft 118 is part of the rotary drive of the vehicle (not shown) to which the centrifugal mass drive 68 provides propulsion power for linear motion.

Another modification that may be added to the propulsion version of the mass drive 68 would be the elimination of the orbital chambers 90 and 108. The orbital rotors 86 and 104 can be placed inside and attached to the body of the rotors 80 and 82. A further modification involves the redesign of the stator 76 to include a close circuit raceway. The modified raceway would allow the wheels 94 and 112 to maintain contact with the raceway as they orbit all the way around the shat 72.

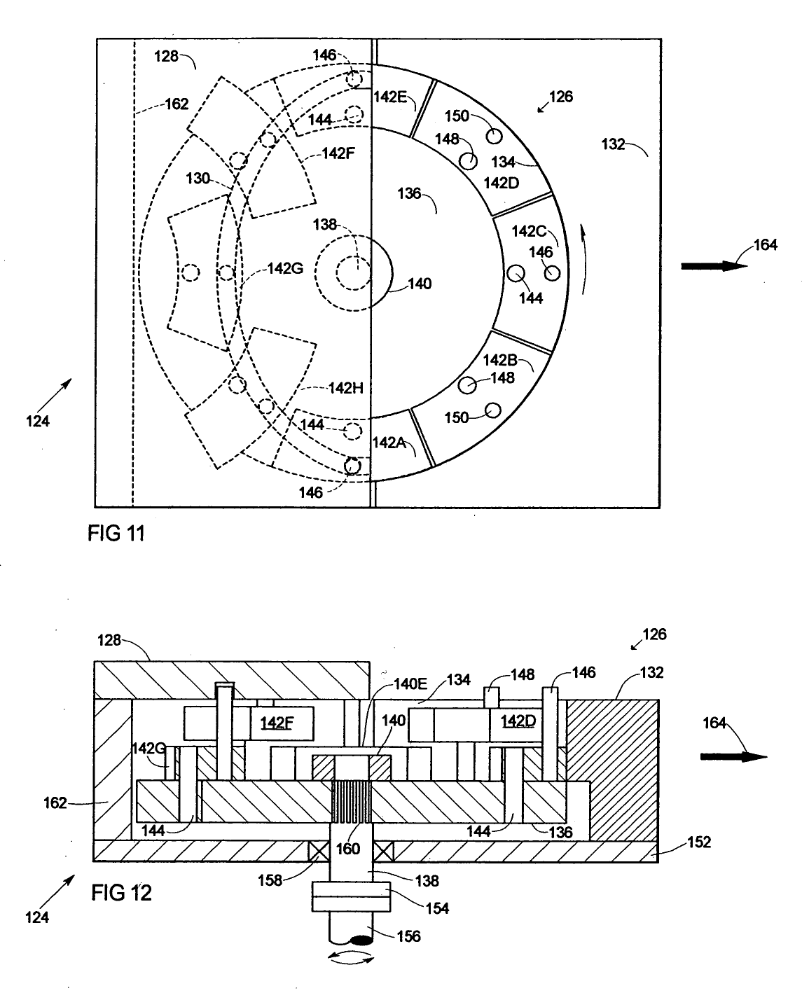

### FIG. 11 AND FIG. 12

FIG. 11 illustrates a further improvement in unbalanced centrifugal force propulsion. FIG. 11 shows a centrifugal mass drive 124 comprising a centrifugal thrust generator 126 interacting with a radius minimizing stator 128 that has a channel 130, and a centrifugal thrust stator 132 with a thrust wall 134. The thrust generator 126 comprises a rotor 136 carrying a plurality of weights 142A-142H. The weights 142A-142H are arranged on two parallel and adjacent planes of revolution. The weights 142A, 142C, 142E, and 142G, are in one plane of revolution; and the weights 142B, 142D, 142F, and 142H in another plane. Each of the weights 142A-142H have shafts 144 and 148. The weights 142A, 142C, 142E, and 142G have a shaft 144 and able to spin about it, in addition to a guide shaft 146. On another adjacent and parallel plane of revolution to the first plane, the weights 142B, 142D, 142F, and 142H also have a plurality of shafts 148 and also able to spin about it. Each of the weights 142B, 142D, 142F, and 142H also has a guide shaft 150. Each of the weights 142A-142H is able to spin about the shaft 144 and 148 during a part of a cycle of revolution about a central shaft 138. The guide shafts 146 and 150 travel through the channel 130 and act as a level to vary the radius of gyration of the weights 142A-142H to minimize the centrifugal forces produced in the opposite direction during that portion of the cycle of revolution. The channel 130 has a shape that facilitates the counter spin of the weights 142A-142H. The thrust generator 126 is secured to the shaft 138 by a retaining mass 140. The shaft 138 pass through a base frame 152 and connects to a transmission 154. The transmission 154 also connects to a drive shaft 156 that is part of a rotary drive (not shown) that provides torque and power to propel the vehicle to which the mass drive 124 is attached to for propulsion. A bearing 158 provides structural and rotary operation support to the shaft 138. A truss member 162 attaches the stator 128 to the frame 152. A set of gear teeth 160 in the shaft 138, are keyed to the rotor 136 to facilitate the transfer of torque and power for the rotation of the thrust generator 126. The rotation of the generator 126, in cooperation with the stator 128, generates an unbalanced centrifugal force useful for the conversion to a propellantless and linear propulsion force 164.

FIG. 11 shows the weights 142A-142E traveling in the semicircular orbit at a constant radius of gyration about the shaft 138. The weights 142A-142E generates large centrifugal force components in the desired linear force direction of propulsion shown with the arrow of the propulsion force 164. In the drawing of FIG. 11, elements of mass in the weight 142C are at, arriving at, and leaving the position of maximum centrifugal force output. In that position, the weight 142C generates maximum centrifugal force output in the desired direction of propulsion shown with the arrow of the propellantless propulsion force 164. The spread out mass of the weight 142B is approaching the position of maximum centrifugal force output. While the weight 142D already left the position of maximum centrifugal force output in the desired direction of propulsion, and is approaching the position where it will encounter the channel 130 in the stator 128 to start a cycle of reduced centrifugal force output in the direction of propulsion. The large centrifugal force components produced by the weights 142A-142H as they travel in a semicircle, are communicated to the stator 132 by way of contact with the thrust wall 134.

In contrast, the weights 142F, 142G, and 142H are under the effect of the stator 128 and travel through a reduced radius of gyration induced by the elliptical shape of the channel 130. The shape of the channel 130 acts on the shafts 146 and 150 to cause a counter rotating motion on the weights 142A-142H during part of the cycle of revolution. The cooperation between the rotary spin of the rotor 136 and the channel 130 causes the weight 142E to spin in a direction opposite to the rotor 136 spin direction. With the generator 126 spinning in the counterclockwise direction, the weight 142E is at the end of the semicircular trajectory of travel through the stator 132, and about to begin a journey of counter rotation through the channel 130. The shaft 146 in the weight 142E enters the channel 130 and starts a clockwise rotation about the shaft 144 while it simultaneously revolves about the shaft 138 with the rotor 136. The weight 142F is already in the process of decreasing its own radius of gyration as it approaches the position of minimum radius of gyration. The weight 142G is in a midway position where it attains a minimum radius of gyration with respect to the shaft 138. In the position of minimum radius of gyration, the weight 142G generates minimized opposing centrifugal forces. The next weight 142H is at some distant away from the position of minimum radius, and approaching the position where it ends the output of opposing centrifugal forces where it will start a new cycle of centrifugal force output in the direction of propulsion. The weight 142A is in transition, at the end of the counter rotation cycle, and at the beginning of the constant radius trajectory path from side to side on the stator 132.

In a cycle of centrifugal force propulsion, a mass starts a journey of semicircular travel at a constant radius of gyration. As the mass travels in contact with the thrust plane of the wall 134, it produces centrifugal force components in the desired direction of linear force propulsion. It reaches a point of maximum centrifugal force output in the direction of propulsion. Then the mass moves away and travels to reach the point where it start a new cycle of counter-rotation to achieve a minimum radius of gyration and minimum centrifugal force output components in the direction opposite to the desired direction of propulsion. Then it arrives once again at the starting point where it starts a new cycle of centriftigal force output for propellantless propulsion. The net difference between the larger centrifugal force components produced by the weights 142A-142H traveling in a semicircular trajectory, and the smaller centrifugal force component produced by counter-rotation and a reduced radius of gyration generates unbalanced centrifugal force vector components that generate the propulsion force 164.

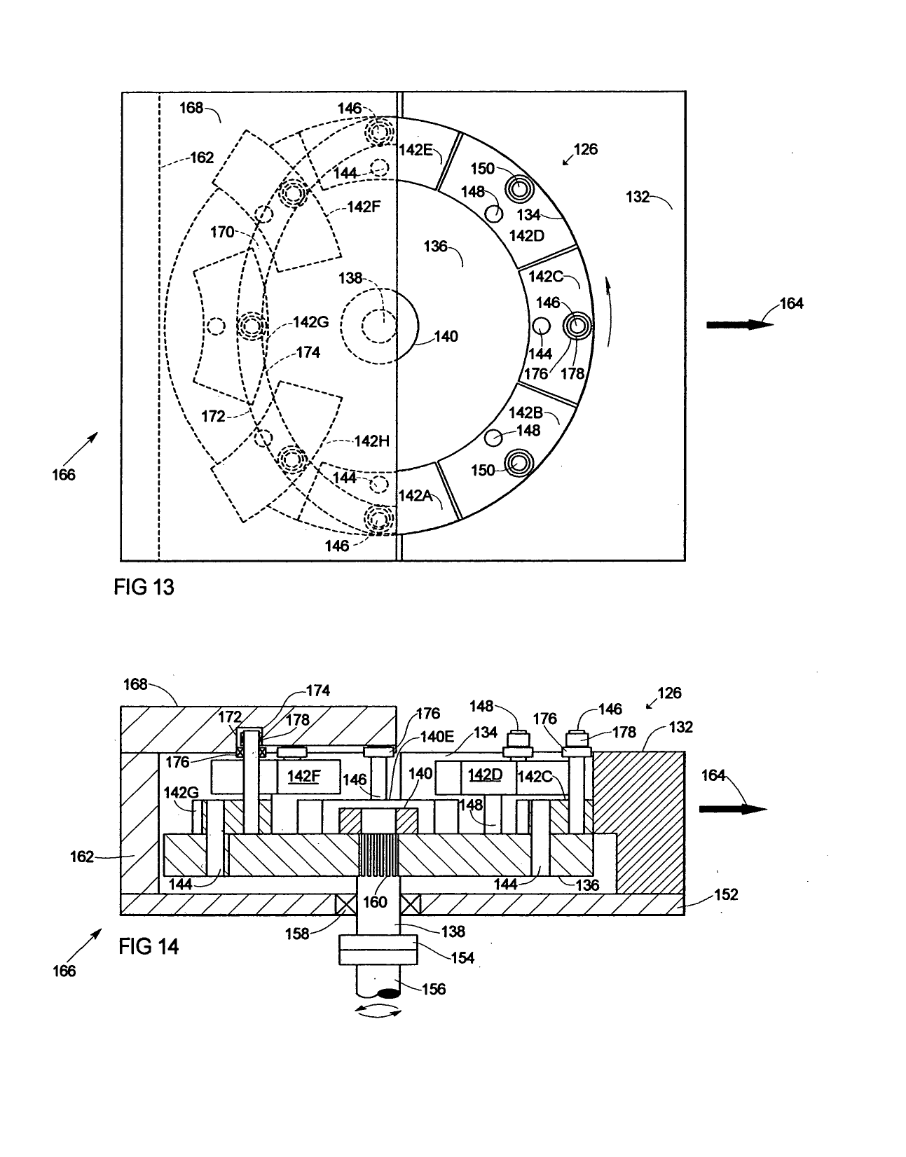

### FIG. 13 AND FIG. 14

Even though the channel 130 may be well lubricated, the motion of the shafts 146 and 150 through the walls of the channel 130 may well generate considerable frictional forces that must be overcome. FIG. 13 shows an improved version of the mass drive 124 in the form of a new centrifugal mass drive 166. FIG. 14 is a cross section of the mass drive 166. The improvements consisting of, a modified radius minimizing stator 168 that includes a modified channel 170 and wheel bearings 176 and 178 added to the shafts 146 and 150. The channel 170 comprises an outer raceway 172, and an inner raceway 174. The wheel bearing 176; travels over the raceway 172. The wheel bearing 178; travels over the inner raceway 174. The addition of the wheel bearings 176 and 178 facilitates the motion of the shafts 146 and 150 through the channel 170 at reduced frictional losses. All similar components in the mass drives 124 and 166 have the same part number and new components with new part numbers. The operation of centrifugal force output for propulsion power in the mass drives 124 and 166 is similar in nature.

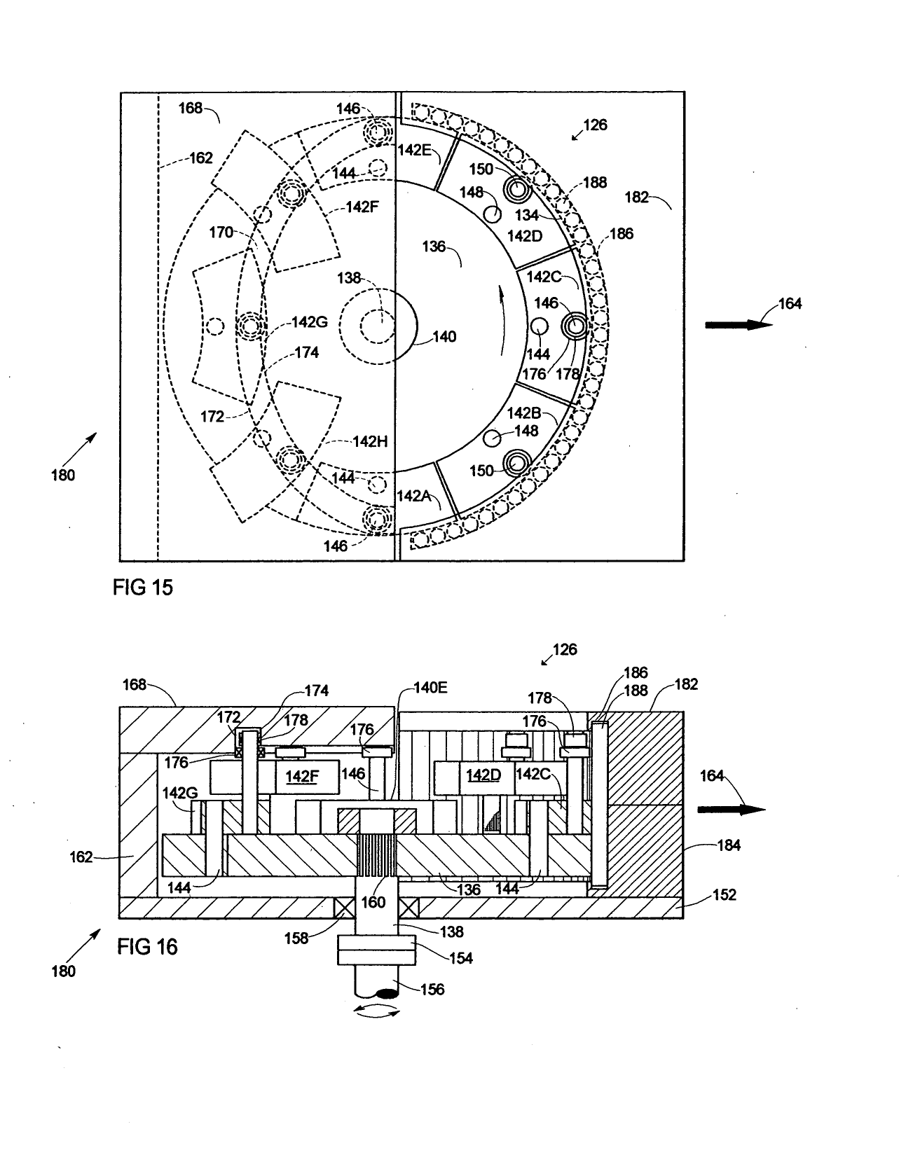

### FIG. 15 AND FIG. 16

FIG. 15 shows further advancement in unbalanced centrifugal force propulsion in the form of an improved centrifugal mass drive 180. The mass drive 180 is a further improvement and advancement over the mass drive 124 by way of the mass drive 166. FIG. 15 is a plan view of the improved centrifugal mass drive 180; and FIG. 16 is a cross section. The improvements consisting of, a modified stator 132 in the form of, an upper thrust stator 182 joining a lower thrust stator 184, with both stators 182 and 184 members put together to form a channel 186 to accommodate a plurality of rollers 188. As an operating unit, the rollers 188 act like a bearing to decrease the frictional contact between the weights 142A-142H and the stators 182 and 184. The end result is the output of an unbalanced centrifugal force expressed as the linear force shown with the vector arrow of the propulsion force 164. The thrust output operation of the drive 180 will not be discussed any further since it is the same as the operation of the mass drives 124 and 166.

An additional improvement fit to implement in the mass drives 124, 166, and 180 involves the modification of the stators 128 and 168 to include a closed circuit channel. The channels 130 and 170 can be modified to extend all the way around to form a close circuit. In addition, the channel 130 can be modified to include rollers as a bearing within its structure to reduce the friction produced by the shafts 144 and 150 in the channel 130. Additional modifications would include the shape and curvature of the channels 130 and 170 to facilitate the counter-rotation of the weights 142A-142H during the act of radius of gyration minimization. Further modifications may include adjustments on the distribution of mass on each of the weights 142A-142H.

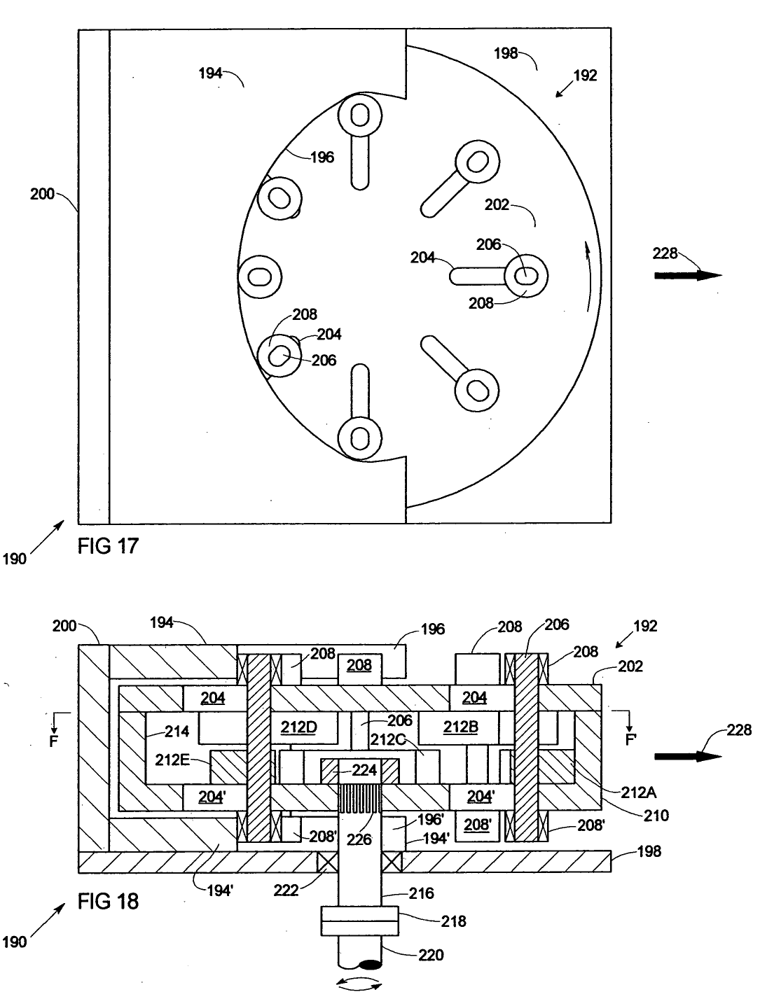

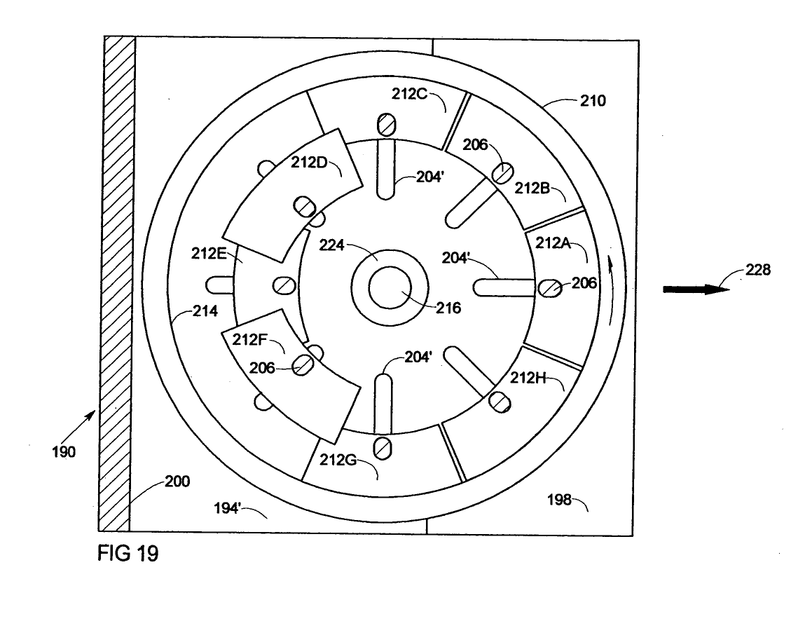

### FIG. 17, FIG. 18, AND FIG. 19

FIG. 17 is a plan view of a centrifugal mass drive 190; and FIG. 18 shows its cross section. The mass drive 190 is another derivation from the continuous distribution of mass approach suitable for steady state propellantless propulsion. The mass drive 190 comprises a centrifugal thrust generator 192 in operation with two similar radius minimizing stators 194 and 194′. The stators 194 and 194′ have raceways 196 and 196′. A brace 200 attach the stator 194 to a base frame 198. The stator 194′ mounts directly onto the base frame 198. The generator 192 comprises a rotor cover 202 with a plurality of radial slots 204, a plurality of shafts 206, each of the shafts 206 has a wheel bearing 208 on one end, and a wheel bearing 208′ on the other end, a rotor 210 shaped like a cylindrical deep dish to hold within a plurality of weights 212A-212H (shown in FIG. 19) to generate the centrifugal forces made available for propellantless propulsion. The rotor 210 has an internal rotor wall 214 on which the weights 212A-212H press on with centrifugal forces by direct contact with thrust plane represented by the wall 214. The weights 212A-212H travel in orbit about a central shaft 216. The rotor 210 is attached to the shaft 216 and secured by a mass 224. The shaft 216 passes through the frame 198 to link up with a transmission 218. The transmission 218 also connects to a drive shaft 220. The shaft 220 is part of the rotary drive in the vehicle (not shown) to which the centrifugal mass drive 190 is mounted on for propulsion. The drive shaft 220 makes available torque and power to the transmission 218. A bearing 222 in the frame 198 supports the shaft 216. The shaft 216 has a set of gear teeth 226 on one end to couple with the thrust generator 192 and transfer the torque from the transmission 218 to spin the generator 192. The synergy between the spinning thrust generator 192 and the radius minimizing stators 194 and 194′ generates the directional unbalanced centrifugal forces that generate the propulsion force 228.

FIG. 19 is an internal view of the weights 212A-212H inside the rotor 210 along the line FF′ in FIG. 18. The weights 212A-212H are in the various positions through which they may pass through in transit during a cycle of revolution around the shaft 216.

### Operation

To produce the unbalanced centrifugal forces that generate the vector of the propulsion force 228, the weights 212A-212H changes their orbital trajectory about the shaft 216 by changes in radius of gyration. FIG. 19 demonstrate another view taken along the line FF′ in FIG. 18. FIG. 19 shows the various positions and the radius of gyration of the weights 212A-212H in a cycle of revolution. For the duration of a cycle of revolution about the shaft 216, each of the bearings 208 and 208′ come in contact with the raceways 196 and 196′. The curvature of the raceways 196 and 196′ determines the minimum radius of gyration and how close to the shaft 216 any of the weights 212A-212H may approach. FIG. 17 shows various wheel bearings 208 locations on the raceway 196 as it relates to the positions of the weights 212A-212H.

FIG. 19 shows the positions of the weights 212A-212H during one particular instance of time in a cycle of revolution. To make the propellantless propulsion force 228, the thrust generator 192 is shown spinning counterclockwise. Inside the rotor 210, the weights 212A-212H generate centrifugal forces of various magnitudes in the direction of propulsion in accordance to the position of the weights 212A-212H. FIG. 19 shows the weight 212G at the beginning of a cycle of revolution in orbit around the shaft 216. The weight 212G is also at the end of a cycle of travel through the trajectory of minimum radius of gyration; and at the start of a new orbital trajectory that will take it to the point of maximum contribution of centrifugal thrust in the direction of propulsion behind the weight 212H. The mass of the weight 212H is in motion toward the position that generates maximum amount of centrifugal forces in the direction of propulsion following behind the weight 212A. In that position, the weight 212H generates centrifugal force vector components in the direction of the force 228. The weight 212A is in the position of maximum contribution of centrifugal force vector components in the desired direction of propulsion. Constituents of mass in the weight 212A are in the position of maximum centrifugal force output in the direction of the propulsion force 228. Other elements of mass in the weight 212A are arriving at, and others are leaving the position of maximum centrifugal force contribution to propulsion. While the weight 212B, is already at a distance away from the position of maximum contribution of centrifugal force components in the direction of maximum thrust. Yet, the weight 212B contributes smaller centrifugal force components to the vector of the propulsion force 228. The weight 212C is at the end of the semicircular orbit trajectory about the shaft 216, and at the start of an orbit trajectory that will take it through the point of minimum radius of gyration. Best shown in FIG. 19; the weights 212G, 212H, 212A, 212B, and 212C travel in a semicircular trajectory of constant radius of gyration, pressing against the rotor wall 214 with the magnitude of the centrifugal force they produce. FIG. 19 shows that in this particular instance, the weights 212G, 212H, 212A, 212B and 212C pass through the point of maximum centrifugal force contribution in the direction of the propulsion force 228 in a constant and continuous steady state of mass flow. Thus, the centrifugal forces produced by the weights 212A-212H is also a constant and continuous output.

In contrast, the mass of the weight 212D is in a position approaching the minimum radius of gyration as measured from the shaft 216. In this position, the weight 212D generates minimized centrifugal force components opposing the direction of the force 228. The wheel bearing 208 and 208′ on the shaft 206 that belongs to the weight 212D, are in contact with the raceways 196 and 196′. The contact with the raceways 196 and 196′ causes the weight 212D to slide inward through the radial slots 204 and 204′ in order to reduce the radial distance from the central shaft 216; thus a change in the orbit trajectory of the weight 212D comes as a result. The next weight 212E is already in the position of minimum radius of gyration. In that position, components of mass in the weight 212E contribute smaller centrifugal force components in opposition to the direction of the propulsion force 228. Sliding inwards in the slots 204 and 204′ causes the weight 212E to slide to the inner end of the slots 204 and 204′, closer to the shaft 216. FIG. 19 also shows the weigh 212A at the outermost end of the slots 204 and 204′. The radial position of the weights 212A and 212E is also shown in FIG. 18. In reference to the radial slots 204 and 204′, they are similar and equally spaced at the same radial distance from the shaft 216, and angularly spaced at equal distances from each other. The next weight 212F already left the position of minimum radius of gyration, approaching the end of the journey through the orbit that generates small but opposing force to the vector of the propulsion force 228. The path of the weights 212D, 212E, and 212F is in an orbital trajectory away from the thrust plane of the rotor wall 214. The differential between the opposing centrifugal forces produced by the weights 212A-212H generate an unbalanced centrifugal force in the direction of the larger centrifugal force. As the thrust generator 192 spin in any chosen direction, the weights 212A-212H go through a similar and repetitive centrifugal thrust output cycle to produce the unbalanced centrifugal forces that generate the vector of the propellantless propulsion force 228.

In the illustrations of FIG. 18 and FIG. 19, it can be seen that the weights 212A, 212C, 212E, and 212G, and the weights 212B, 212D, 212F, and 212H operate in two adjacent and parallel planes of rotation. The two dimensional view in FIG. 19 shows that during a cycle of revolution, the weights 212A-212H will always form a continuous distribution of mass on one side of the rotor 210. FIG. 18 shows that the wall 214 provides a thrust plane for the centrifugal forces to act on. The mass of the weights 212A, 212B and 212C press against the wall 214. In FIG. 19 it can be seen that the weights 212A, 212B, 212C, 212G, and 212H press against the wall 214 to transfer unbalanced centrifugal forces to the shaft 216. The unbalanced centrifugal forces make up the propulsion force 228 that propel the vehicle to which the centrifugal mass drive 190 is attached to.

Among the modifications and improvements that may be put into effect in the design of the mass drive 190, it may include the redesign of the shafts 206 by replacing it with shorter shafts. For example, the weights 212A, 212C, 212E, and 212G with short shafts will slide in the slots 204′ only; guided by the curvature of the raceway 196′. On the next level and adjacent plane of revolution, the weights 212B, 212D, 212F, and 212H with short shafts in each mass, are confined to slide in the slots 204 only. The curvature of the raceway 196 will determine the radius of gyration.

### CONCLUSION, RAMIFICATIONS, AND SCOPE OF INVENTION

Propellantless propulsion is the propulsion technology for the twenty-first century. As the reader can see from the descriptions and illustrations herein, the centrifugal mass drive is a novel and useful propulsion engine. The descriptions above contain many specificities that show a richness of possibilities and approaches useful for the realization of practical propellantless propulsion. The descriptions herein should not be construed as limitations on the scope and range of the invention. The specificities in the text are only exemplifications of some of the presently preferred embodiments. There are additional embodiments relevant to propellantless propulsion, for example:

The centrifugal mass drives 10 and 58 can be improved by redesigning them to include radial slots technology in the body of the rotor 30. The gears 36A-36H and 38A-38H may be designed to slide inward in order to implement a further decrease in radius of gyration. Another modification may include distribution of mass in the shape and volume of each of the weights 32A-32H.

In another embodiment relevant to the development of the mass drive 68, the rotors 80 and 82 can be changed to flat disk rotary platforms, with the addition of a stationary thrust stator to control the orbital trajectory of the weights 84A-84B and 102A-102B during part of a cycle of revolution. Another modification may include radial slots as a technique for the reduction of radius of gyration. A further improvement may include the addition of one way rotary direction control devices in the orbital rotors 86 and 104 that will allow counter-rotation in one direction only. Moreover, there are other mechanisms that can be used with the orbital rotors 86 and 104 for spin direction control.

Another improvement on the mass drives 124, 166, and 180 may include radial slots for further reductions in radius of gyration. Another modification may include suitable orbital rotors for the counter-rotation of the weights 142A-142H during the fraction of the cycle of revolution they operate to alter the radius of gyration. Another combination may include the use of both, radial slots and orbital rotors. Also, the very same mass drives 124, 166, and 180 may be redesigned to include these proposed modifications inside a deep dish shaped rotors, as in the rotors 80 and 82, which would result in the elimination of the thrust stators 132 and 182.

In another embodiment relevant to the design of the mass drive 190 would include, adding suitable orbital rotors in bearings embedded within the cover 202 and the body of the rotor 210. The new orbital rotors will provide the change in radius of gyration by way of counter-rotation, or in combination with orbital rotors that will slide in the radial slots.

In all the embodiments above, the design of the masses that generate the centrifugal forces for propulsion may include a suitable variable mass distribution on each of the weights. A variable distribution of mass will help to achieve a constancy of steady state thrust in accordance to the design approach of the particular centrifugal mass drive in consideration.

In the embodiments of the centrifugal mass drives herein, the reader will see the descriptions of a novel propellantless prime mover; useful for the propulsion of on land motor vehicles such as railway cars, automobiles, trucks, buses, and vans. In combination with the traction of the vehicle's own wheels, the application of a centrifugal mass drive for on land propulsion is well suited for the augmentation of the vehicles own propulsion power as already present. A centrifugal mass drive can also eliminate the need for a drive train. The use of a centrifugal mass drive for on land propulsion will improve and even increase the miles per gallons efficiency of on land motor vehicles.

In naval operations, a centrifugal mass drive is useful and well suited for marine propulsion Instead of the water dependent marine propeller, a centrifugal mass drive can provide the thrust for the ship propulsion on water. The marine application of centrifugal mass drives comes without the attached turbulence and losses of marine propellers. In submarines, the elimination of the submarine's propeller will yield a high and considerable reduction in submarine noise and drag. It will also reduce the fuel consumption due to improved propulsion efficiency.

In aviation, a propellantless centrifugal mass drive is useful for the propulsion of manned and unmanned aircrafts and related aerospace vehicles. A centrifugal mass drive coupled with a power source such as an electric motor, a turboshaft engine, or an internal combustion engine is applicable for the enhancement of the current propulsion technology in aviation. As an added benefit, the centrifugal mass drive will deliver a considerable reduction in fuel consumption to increase the aircraft's performance, speed and range, with the added benefit of reductions in the cost of aircraft operations.

Another application relevant to aerospace vehicles is the development of lift and thrust platforms based on the technology of centrifugal mass drives. A single or several centrifugal mass drives placed vertically can be employed to generate vectored lift for hover, flight, up and down motion, rearward motion and forward thrust for propulsion. In the horizontal position, a centrifugal mass drive can provide vectored thrust for forward, rearward motion, and lateral direction control. The combination of vertical and horizontal centrifugal mass drives in a flight platform can provide propulsive lift for hover, flight, and thrust for motion and three dimension direction controls about the platform axes.

One example of a new application of centrifugal mass drive technology in aviation would be in the development of a fly-pack; a small lightweight strap-on your back propulsive lift and thrust for personal use in transportation, flying sports competition, and the personal enjoyment of flight. With the application of centrifugal mass drive technology, the best of a new generation of civilian and military aerospace vehicles never before conceived will be possible.

In space exploration, a centrifugal mass drive has the obvious advantage that it can propel a space carrier without the need for propellant. A centrifugal mass drive with an electric motor; or electric motor technology specifically designed and integrated with a centrifugal mass drive can operate with electricity produced by solar cells and photons from the sun and nearby stars, or from an onboard electric or nuclear power plant. With propellantless propulsion technology, it will be possible for a spaceship to approximate the speed of light after a period of sustained acceleration. The same benefits and advantages apply to the operation of satellites and robotic spaceships far out into space or in orbit around the earth and other planets. By way of space travel, the advantages of propellantless propulsion will provide mankind unprecedented access to the universe far out there and beyond.

In addition to these and other development in space applications, with centrifugal mass drive technology, it will be possible to build a space vehicle that; in the same manner that a helicopter and an airplane climbs and descends to any given altitude, the spacecraft can ascend and descend to any altitude in air and in space. Instead of employing the brute force approach common in rockets, space shuttles, and satellites, with a centrifugal mass drive, a more flexible and controllable flight and navigation space vehicle can be developed.

In the descriptions and explanations above, the reader will see that a centrifugal mass drive is a novel propellantless prime mover. The descriptions herein contain various exemplifications that should not be construed as the limitations of the embodiments. There are variations, derivatives, and ramifications beyond those illustrated in the text; and those familiar with the art are capable of adapting and putting into practice new modifications and improvements without ever departing from the spirit of the invention. As a field in search of progress, the development of propellantless propulsion technology is inescapable. Here and now, propellantless propulsion, the invention of the force in a new machine, is the worthwhile goal of propulsion technology in the 21st century.

I claim:

1. A method for the operation of a propellantless propulsion device comprising,
providing means in a plurality of masses for producing centrifugal forces,
providing a rotary platform means to carry and convey rotary energy to said masses,
providing means for altering the radius of gyration of said masses on said rotary platform during part of a cycle of revolution,
providing static means comprising the thrust plane of a wall for steering said weights in a semicircular orbit and for receiving the said centrifugal forces generated by said masses during part of a cycle of revolution,
whereby the centrifugal forces generated by the rotary motion of said platform carrying said masses generates a propellantless propulsion force.

2. The propulsion device in claim 1 wherein said static means is modified to reduce the friction between said centrifugal force generating masses and said thrust plane of said wall.

3. A method for the operation of a propellantless propulsion device comprising,
providing means for generating centrifugal forces in the form of a sequence of weights,
providing a rotary platform means to carry and convey rotary energy to said weights,
providing a second rotary platform means for producing centrifugal forces arranged in a sequence of weights,
providing a second rotary platform means to carry and convey rotary energy to said second plurality of weights,
providing means for altering the radius of gyration of said weights on said rotary platforms during part of a cycle of revolution,
whereby the centrifugal forces generated by the rotary motion of said rotary platforms carrying said weights generates a directional propellantless propulsion force.

4. A method for the operation of a propellantless propulsion device comprising, providing means for producing centrifugal forces in the form of weights, said weights with steering means for altering the weights radius of gyration during part of a cycle of revolution,
providing a rotary platform means to carry and convey rotary energy to said weights,
providing stationary means with a channel for reducing the radius of gyration of said weights during a part of the total time in a cycle of revolution,
providing means comprising the thrust plane of a wall for steering said weights in a semicircular orbit and for receiving the centrifugal forces generated by said weights during part of a cycle of revolution,
whereby the centrifugal forces generated by the rotary motion of said platform carrying said weights generates a linear propellantless propulsion force.

5. The propulsion device in claim 4 wherein said steering means is modified to include means to reduce the friction between said the steering means and said channel during changes in the radius of gyration of said weights.

6. The propulsion device in claim 5 wherein said thrust plane wall is modified to include means to reduce friction between said weights and said wall.

7. A method for the operation of a propellantless propulsion device comprising,
providing means for producing centrifugal forces arranged in a plurality of weights, said weights with steering means for altering the radial position of said weights during a cycle of revolution,
providing a rotary platform means to carry and convey rotary energy to said weights, said rotary platform with radial slots to facilitate changes in radius of gyration of said weights during a portion of a cycle of revolution,
providing stator means with a raceway for altering the radius of gyration of said weights during a portion of the time in a total cycle of revolution,
whereby the centrifugal forces generated by the rotary motion of said platform carrying said weights generates a directional propellantless propulsion force.
